(19) United States
(12) Patent Application Publication
(10) Pub. No.: US 2016/0072959 A1
(43) Pub. Date: Mar. 10, 2016

(54) METHOD AND SYSTEM FOR IP COMMUNICATION COMPLETION VIA A WIRELESS NETWORK

(71) Applicant: VONAGE NETWORK LLC, Holmdel, NJ (US)

(72) Inventors: Mabrouk Aboughanaima, Matawan, NJ (US); Richard H. Gibson, III, Howell, NJ (US)

(21) Appl. No.: 14/482,282

(22) Filed: Sep. 10, 2014

(51) Int. Cl. H04M 7/12; H04L 29/06; H04W 4/14; H04W 76/02

(52) U.S. Cl. CPC H04M 7/1235; H04W 76/02; H04L 65/1069; H04L 65/1006; H04W 4/14; H04L 65/1073; H04M 7/126

(57) ABSTRACT

Methods and systems for internet protocol (IP) communication completion via a wireless network include receiving a request from a first device to setup an IP telephony communications session with a second device, generating, based on user device data retrieved for the second device, a first message based on a first communication protocol including telecommunication invitation data to complete the IP telephony communications session, sending the first message to the second device, receiving a response message based on a second communication protocol from the second device, and connecting the second device with the first device to establish the IP telephony communications session.

### BACKGROUND OF THE INVENTION

1. Field of the Invention

Embodiments consistent with the present invention generally relate to a method and system for establishing a communication session in an IP network.

2. Description of the Related Art

A landline telephone (also known as main line, home phone, land-line, fixed-line, and wireline) typically refers to a user communication device that uses a solid metal wire or fiber optic cable for communication transmission with a telephone communication provider as distinguished from a mobile cellular line which uses radio waves for transmission. Landline user communication devices, such as for example an analog telephone device, may establish calls with others using internet protocol (IP) communication sessions (e.g., Voice-over IP (VolP)) via an IP terminal adapter (TA) that connects the landline user device to an IP network. A dedicated channel must be maintained between the IP network and the TA/landline user device in order for the user device to receive a call for a communications session. Often, this channel is routed through a firewall or local router of the user device that must reconcile a network address translation (NAT). In network communications, keeping a port open to maintain this channel requires keeping the channel active by transmitting artificial data packets (e.g., packets without meaningful payload data) through the channel.

Transmission of the artificial data packets over time can amount to large amounts of bandwidth consumption that are taxing on the Internet provider of the user device on a landline. For TAs that are connected to an IP network via wireless cellular data connections, such as Long-Term Evolution (LTE), the cost is even higher as many cellular providers have imposed a limit on the amount of data communicated between devices.

Accordingly, there is a need for a method and system for completing an internet protocol (IP) communications session via a wireless network without maintaining a constant active communication channel.

### SUMMARY OF THE INVENTION

Methods and systems for internet protocol (IP) communication completion via a wireless network, including receiving a request from a first device to setup an IP telephony communications session with a second device, generating, based on user device data retrieved for the second device, a first message based on a first communication protocol including telecommunication invitation data to complete the IP telephony communications session, sending the first message to the second device, receiving a response message based on a second communication protocol from the second device, and connecting the second device with the first device to establish the IP telephony communications session.

In some embodiments, a method for completion of an internet protocol (IP) communications session in an IP telephony communications system, includes receiving a first message based on a first communication protocol from a wireless network containing telecommunication invitation data to establish the IP communications session with a first device, generating a response message in a second communication protocol based on the telecommunication invitation data from the first message, sending the response message to the IP telephony communications system to establish the IP communications session with the first device, and communicating with the first device via the IP communications session.

In some embodiments, a system for internet protocol (IP) communication completion via a wireless network includes a text message generation interface, a wireless gateway coupled to a wireless network, and at least one proxy server, the system configured to receive a request from a first device to setup an IP telephony communications session with a second device, generate based on user device data retrieved for the second device, a first message based on a first communication protocol including telecommunication invitation data to complete the IP telephony communications session, send the first message to the second device, receive a response message based on a second communication protocol from the second device, and connect the second device with the first device to establish the IP telephony communications session.

In some embodiments, an apparatus for completion of an internet protocol (IP) communications session in an IP telephony communications system with a recipient device includes a call setup module configured to: receive a first message based on a first communication protocol from a wireless network containing telecommunication invitation data to establish the IP communications session with a first device, generate a response message in a second communication protocol based on the telecommunication invitation data from the first message, send the response message to the IP telephony communications system to establish the IP communications session with the first device, and communicate with the first device via the IP communications session.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram of a communication system including an IP text message adapter in accordance with one or more exemplary embodiments of the invention;

FIG. 2 is a detailed block diagram of a communication system including a text message adapter in accordance with one or more embodiments of the invention;

FIG. 3 is a block diagram of a call establishment unit in the IP telephony network in accordance with one or more embodiments of the invention;

FIG. 4 is a call flow diagram of an exemplary method for completing an IP call using a text message in accordance with one or more embodiments of the invention;

FIG. 5 is a flow diagram of an exemplary method for completing an IP call using a text message in accordance with one or more embodiments of the invention;

FIG. 6 is a flow diagram of an exemplary method for completing an IP call by receiving a text message in accordance with one or more embodiments of the invention; and

FIG. 7 is a depiction of a computer system 700 that can be utilized in various embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention are directed to methods, apparatus, and systems for completing an Internet Protocol (IP) telephony communications via a wireless network. In some embodiments, the methods and systems use text messages to establish an IP telephony communication (i.e., an IP call). A text message (e.g., SMS message) is sent from the IP telephony network to a cellular network to which a recipient device is connected. The recipient device extracts information for initiating an IP call and either directly connects or registers itself with the IP telephony network. Prior to receiving the SMS message, the recipient device does not need to maintain an active channel to the IP telephony network when the recipient device is not in a communications session and waits for the SMS message. In addition, the recipient device may also initiate a call at any time to the IP telephony network without maintaining an active channel. While the disclosed embodiments apply a SMS message protocol, as will be described below, other communication protocols may be used for passive communication to the recipient device.

The embodiments discussed herein may include devices using mobile communications. One non-limiting form of mobile communications is Voice over IP (VoIP), which is utilized to establish and provide voice communications over a data network using the IP. Businesses and individuals implement VoIP by installing the necessary equipment and service (i.e., a “high speed” network or broadband connection) to access a VoIP service provider and activating this telecommunication service. Calls from a VoIP subscriber device to a destination device may be routed via a number of inter-connected networks, such as via the VoIP service provider network, mobile telephone service provider networks, and existing and traditional telecommunications system more commonly referred to as the Public Switched Telephone Network (PSTN) or Plain Old Telephone Service (POTS).

VoIP service providers may provide mobile or desktop VoIP applications (apps) that users can install on their smartphone or other type of mobile or stationary computing devices, or may provide VoIP Telephone/Device Adapters (TA) that can be used with traditional hardwire telephones. Such apps also include over the top (OTT) applications. OTT describes a category of applications where content is delivered without a multiple system operator involved in the control or redistribution of the content.

At least a portion of the call may be transmitted as packets over an IP network, via wireless local area network (WLAN) based on the Institute of Electrical and Electronics Engineers' (IEEE) 802.11x standards for example, rather than over traditional mobile phone mobile communication technology standards (e.g., 2G, 3G, and the like). By transmitting voice as packet data over an IP network, these mobile apps can allow a user to make calls to another OTT client or an off-net destination. They may be used when the user is connected to a base station over the mobile operator's cellular network, over a third-party's WLAN, 802.11x access point, over WIMAX, and the like.

In other embodiments, an electronic device (e.g., analog phone, IP telephone, and the like) that is not connected to a cellular network is coupled to a terminal adapter (e.g., text message adapter). The terminal adapter is configured to receive SMS text messages from the cellular network and communicates with an IP network and VoIP service providers. The terminal adapter completes a connection with the IP network after receiving an SMS text message from the cellular network.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the Apple iPhone™, that includes both cellular telephone capabilities and a wireless data transceiver that can establish a wireless data connection to a data network. Such a mobile computing device could run appropriate application software to conduct VOIP telephone calls via a wireless data connection via the terminal adapter. Thus, a mobile computing device, such as an Apple iPhone™, a RIM Blackberry or a comparable device running Google's Android operating system could be a mobile telephony device. In still other instances, a mobile telephony device may be a device that is not traditionally used as a telephony device, but which includes a wireless data transceiver that can establish a wireless data connection to a data network. Examples of such devices include the Apple iPod Touch™ and the iPad™. Such a device may act as a mobile telephony device once it is configured with appropriate application software.

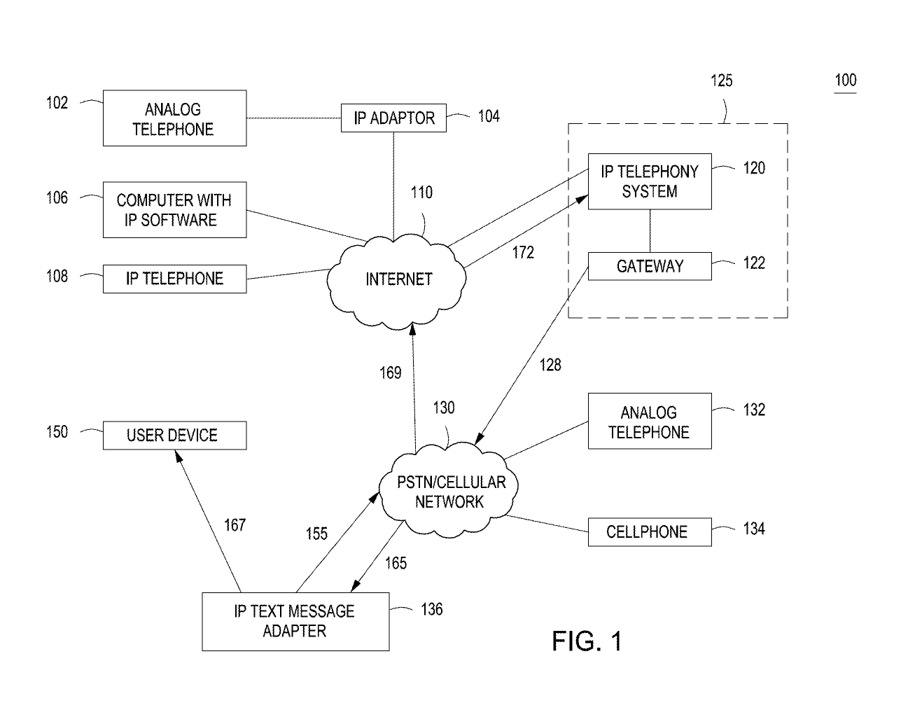

FIG. 1 is a diagram of a communication system 100 including an IP text message adapter 136 in accordance with one or more exemplary embodiments of the invention.

The exemplary communication system 100 includes an Internet 110, an IP telephony system 120, a PSTN/cellular network (hereinafter cellular network) 130, a IP text message adapter 136, and a user device 150. The user device 150 may be any one of the devices shown in the communications system 100: an analog telephone 102 with IP adapter 104, computer with IP software 106, IP telephone 108, cellphone 134, or another combination of a device with a different text message adapter 138. The IP text message adapter 136 is an IP terminal adapter that includes text message receiving and parsing capabilities. The IP text message adapter 136 is configured to communicate with wireless cellular connections (arrow 165) to connect with the cellular network 130, and connects with user device 150 (arrow 167). As will be discussed further below, the IP text message adapter 136 maintains a constant cellular connection to cellular network 130 and upon receiving a text message, establishes a connection to the IP telephony system 120.

The IP telephony system 120 enables connection of telephone calls between its own customers and other parties via data communications that pass over the Internet 110. The IP telephony system 120 and a gateway 122 are part of an IP telephony network 125. The Internet 110 is commonly the Internet, although the IP telephony system 120 may also make use of private data networks. The IP telephony system 120 is connected to the Internet 110. In addition, the IP telephony system 120 is connected to a publicly switched telephone network (PSTN) or cellular network 130 via the gateway 122. The cellular network 130 may also be directly coupled to the Internet 110 through one of its own internal gateways (not shown). Thus, communications may pass back and forth between the IP telephony system 120 and the cellular network 130 through the Internet 110 via a gateway maintained within the cellular network 130.

The gateway 122 allows users and devices that are connected to the cellular network 130 to connect with users and devices that are reachable through the IP telephony system 120, and vice versa. In some instances, the gateway 122 would be a part of the IP telephony system 120. In other instances, the gateway 122 could be maintained by a third party. In other embodiments, the gateway 122 is a wireless gateway that facilitates the communication between the IP telephony system 120 and the cellular network 130

An analog telephone 102 is communicatively coupled to the Internet 110 via an IP adapter 104. The IP adapter 104 converts analog signals from the analog telephone 102 into data signals that pass over the Internet 110, and vice versa. Analog telephone devices include but are not limited to standard telephones and document imaging devices such as facsimile machines. A configuration using an IP adapter 104 is common where the analog telephone 102 is located in a residence or business. Other configurations are also possible where multiple analog telephones share access through the same IP adapter. In those situations, all analog telephones could share the same telephone number, or multiple communication lines (e.g., additional telephone numbers) may be provisioned by the IP telephony system 120. As will be discussed below, IP text message adapter 136 includes additional functionality and modules that can communicate on a wireless cellular network and receive and parse text messages, such as SMS messages, to enable user device 150 to complete an IP telecommunication connection. In other embodiments, the IP text message adapter 136 may receive other out of band signals using protocols that do not rely on active communication channels between the IP telephony system 120 and IP text message adapter 136. For example the IP text message adapter 136 may receive instead a multimedia messaging service (MMS), TMS short codes, and other communication protocols.

In addition, a customer could utilize a soft-phone client running on a computer with IP software 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to an IP adapter 104 that is connected to one or more analog telephones 102.

Users of the communication system 100 are able to access the service from virtually any location where there is an available connection to the Internet 110. Thus, a customer/user could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize the data channel of a cellular telephone system to access the Internet 110.

A third party using an analog telephone 132 which is connected to the cellular network 130 may call a customer of the IP telephony system 120. In this instance, the call is initially connected from the analog telephone 132 to the PSTN network 130, and then from the PSTN network 130, through the gateway 122 to the IP telephony system 120. The IP telephony system 120 then routes the call to the customer's IP telephony device. A third party using a cellphone 134 could also place a call to an IP telephony system customer, and the connection would be established in a similar manner, although the first link would involve communications between the cellphone 134 and a cellular network.

In some embodiments, telephony communications are effectuated over a packet-based data network. Signaling that is conducted in the packet-based data network is preferably executed using Session Initiation Protocol (SIP). However, other messaging protocols besides SIP may be used to connect to the IP telephony system 120. SIP is a popular communication protocol for initiating, managing, and terminating media (e.g., voice, data and video) sessions across packet-based data networks that typically use the Internet Protocol (IP), of which VOIP is an example. The details and functionality of SIP can be found in the Internet Engineering Task Force (IETF) Request for Comments (RFC) Paper No. 3261 entitled, “SIP: Session Initiation Protocol,” that is herein incorporated in its entirety by reference.

In operation, a call originating from the Internet 110 (e.g., from IP telephone 108), requests a connection to the user device 150 via the IP telephony system 120. The IP telephony system 120 retrieves customer and device information to determine that a number is mapped to a specific device on the cellular network. The IP telephony system 120 then sends a text message to the IP text message adapter 136 associated with the phone number. The text message is generated by the IP telephony system 120 and routed through the gateway 122 to the cellular network 130 (shown as arrow 128) in order to connect to the IP text message adapter 136. The IP text message adapter 136 receives the text message (e.g., short message service SMS, short message service center SMSC, and the like) shown as arrow 165, and decodes and/or parses connectivity data from the text message. In some embodiments, the connectivity data may include IP addresses, port numbers, device identifiers, subscriber identifiers, authentication information, time to connect, and the like. The IP text message adapter 136 then directly connects to the IP telephony system 120 by responding with a SIP OK message (shown as arrow 155) or other type if IP communication message to establish a call between user device 150 and IP telephone 108, for example. In embodiments where the user device 150 is an analog telephone, the SIP OK message may be generated by the IP text message adapter 136 that also operates as an IP adapter to allow the analog device to receive and initiate VoIP calls. Upon receiving the SMS text message (arrow 165), the SIP OK message (shown as arrow 155) is routed through the cellular network 130 to the Internet (via arrow 169) to reach the IP telephony network 125 (shown as arrow 172). In some embodiments, the SIP OK message is sent based on an IP address extracted from the SMS text message received by the IP text message adapter 136.

In alternative embodiments, the IP text message adapter 136 may send a response or registration message to the IP telephony system 120 to register with the IP telephony system 120. In either embodiment, the IP telephony system 120, having located the IP text message adapter 136 (and user device 150), may establish an IP telephony communications session between the IP telephone 108 and the user device 150. As will be discussed further below, the IP text message adapter 136 operates in a “standby” mode while waiting for incoming calls from the IP telephony system 120.

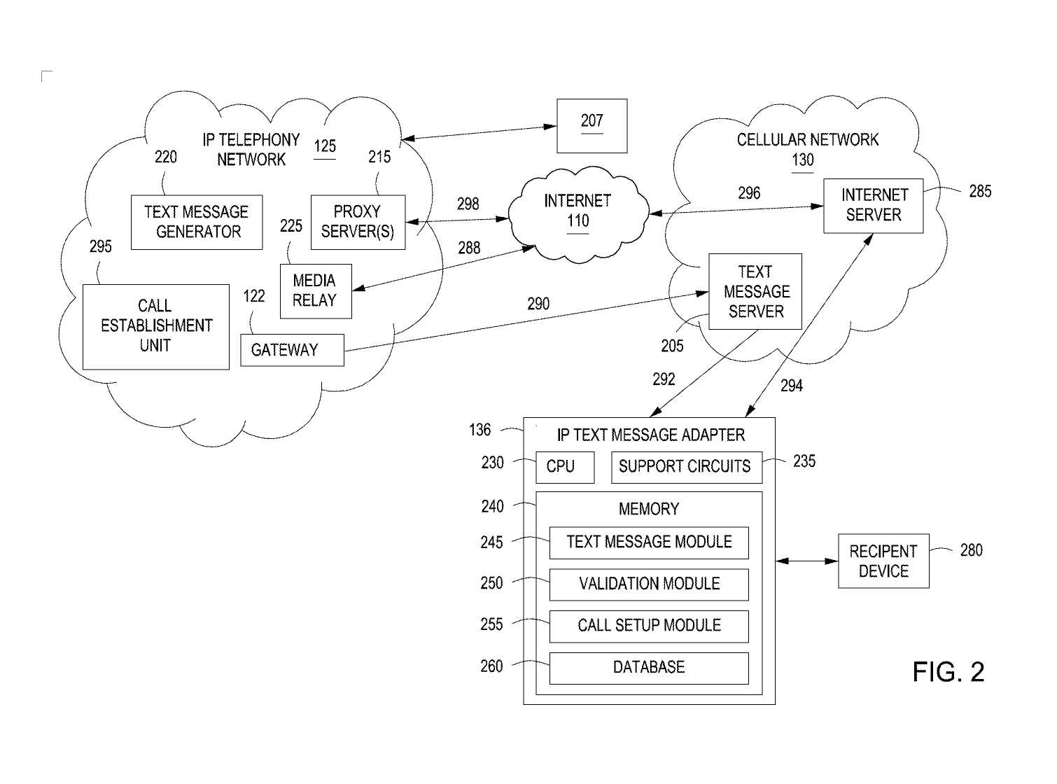

FIG. 2 is a detailed block diagram of a communication system 200 including an IP text message adapter 136 in accordance with one or more embodiments of the invention. The communication system 200 may be used to communicate among devices and as part of the communication system 100 described above in FIG. 1.

The communication system comprises a calling device 207, an IP telephony network 125, a cellular network 130, an IP text message adapter 136, and a recipient device 280. The calling device 207 and recipient device 280 may each be any one of the devices shown in the communications system 100: an analog telephone 102 with IP adapter 104, computer with IP software 106, IP telephone 108, or cellphone 134.

The IP telephony network 125 comprises at least one proxy server 215, a text message generator 220, a gateway 122, a media relay 225, and a call establishment unit 295. The call establishment unit 295 coordinates the devices in the IP telephony network 125 to complete a call connection between the calling device 207 and recipient device 280. The at least one proxy server 215 receives and processes requests to various electronic communication devices communicatively coupled to the IP telephony network 125 using SIP messages and HTTP messages. The text message generator 220 creates text messages carrying a data payload that signals to the IP text message adapter 136 to connect to the proxy server 215. The gateway 122 coordinates with the cellular network 130 to send any generated text messages (shown as arrow 290). The text messages contain a data payload to complete a call initiated by the calling device 207. The time for call completion is relatively instantaneous (e.g., 1-2 seconds).

The media relay 225 coordinates communication data stream exchanges between user devices (e.g., calling device 207 and recipient device 280). The data streams (arrow 288) may include video and audio packets, for streaming communication between the calling device 207 and recipient device 280 in the communications session. The data packets are routed through the IP telephony network 125, the Internet 110, and cellular network 130 to the IP text message adapter 136. The data packets for the communications session may include streaming audio and video transmitted using the real-time transport protocol (RTP). The details and functionality of RTP can be found for example, in the Internet Engineering Task Force (IETF) Request for Comments Paper No. 3550. In alternative embodiments, the media relay 225 is used to communicate between three or more user devices in a conference session across the IP telephony network 125. Further embodiments include peer-to-peer connections that do not rely on the media relay 225.

The cellular network 130 comprises cellular towers and servers (not shown), an Internet server 285, and a text message server 205. The cellular towers and servers facilitate voice and data communications between user devices, the Internet, and completing calls with POTS telephone devices. The Internet server 285 operates as a gateway to access the Internet 110 and exchange data between the Internet 110 and the IP text message adapter 136 and other devices communicatively coupled to the cellular network 130. The text message server 205 uses SMS, SMSC, and the like to send text messages to user devices communicatively coupled to the cellular network 130.

The IP text message adapter 136 is coupled to the recipient device 280. The IP text message adapter 136 allows the recipient device 280 to receive incoming calls without keeping a data channel actively connected to the IP telephony network 125. The IP text message adapter 136 may be a controller or in other embodiments a custom Application Specific Integrated Circuit (ASIC). The IP text message adapter 136 comprises a central processing unit (CPU) 230, support circuits 235, and memory 240.

The CPU 230 may be any commercially available processor, microprocessor, microcontroller, and the like. The support circuits 235 comprise well known circuits that provide functionality to the CPU 230 such as clock circuits, cache, power supplies, I/O circuits, and the like.

The memory 240 may comprise random access memory, read-only memory, removable disk memory, flash memory, and various combinations thereof. The memory 240 is sometimes referred to a main memory and may in part, be used as cache memory or buffer memory. The memory 240 stores instructions comprising an operating system (if necessary), a text message module 245, validation module 250, call setup module 255, and a database 260. The operating system coordinates communication among the modules and the CPU 230 that executes the instructions stored in memory 240. The database 260 may store information about the recipient device 280 and the IP text message adapter 136 such as data for a connection to the cellular network 130 and user account data for connecting to the IP telephony network 125.

The text message module 245 comprises a set of instructions for decoding/analyzing text messages received from the text message server 205. The text message module 245 also parses and extracts communication information, such as IP addresses, port numbers, device identifiers, subscriber identifiers, authentication information, maximum number of connection retry attempts, time to connect, and the like, included in the data payload of the text message to connect to the IP telephony network 125 and complete the communication session. In additional embodiments, the text message module 245 may include instructions to encode text messages originating from the recipient device 280 to send to the cellular network 130.

The validation module 250 comprises a set of instructions to authenticate the text message as originating from the IP telephony network 125. The validation module 250 may access predetermined keys, tokens, or encryption data stored in the database 260 that verifies a text message is from an IP service provider on the IP telephony network 125 to request a call or connection.

The call setup module 255 comprises a set of instructions to send an SIP notification (shown as arrow 294) such as an “SIP OK 200” message to the proxy server 215 using data from the payload of the received text message. The call setup module 255 may also connect then to the media relay 225 and complete the establishment of a communication session with the calling device 207 and recipient device 280 using a proxy server connection (arrow 298) and media relay connection (arrow 225). In addition, arrow 294 also represents the communication channel to exchange audio and/or video data for the established communication session.

In other embodiments, the call setup module 255 registers the IP text message adapter 136 upon receiving the text message. Registration with the IP telephony network 125 then allows the proxy server 215 to coordinate completion of the communication session with the calling device 207 and recipient device 280.

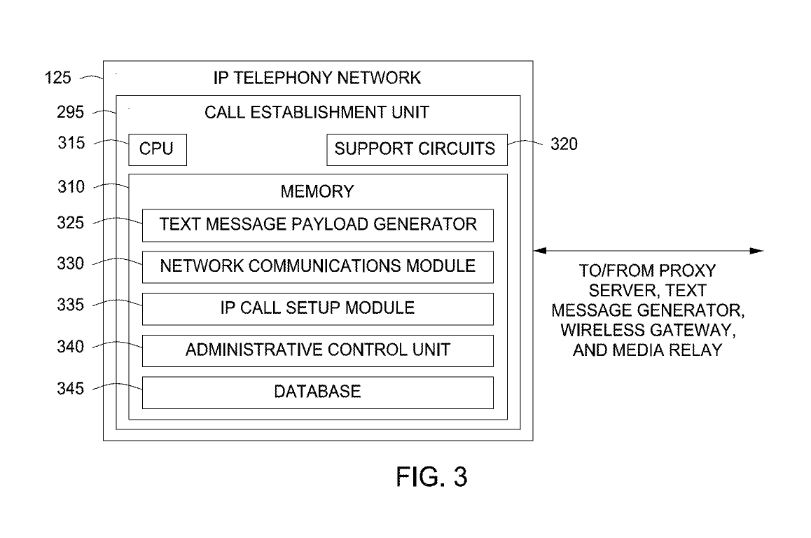

FIG. 3 is a block diagram of a call establishment unit 295 in the IP telephony network 125 in accordance with one or more embodiments of the invention. In some embodiments, the call establishment unit 295 is a part of the proxy server and in other embodiments is a separate controller or server coordinating the communications between the proxy server, text message generator, wireless gateway, and media relay in the IP telephony network 125.

The call establishment unit 295 comprises a central processing unit (CPU) 315, support circuits 320, and memory 310. The CPU 315 may be any commercially available processor, microprocessor, microcontroller, and the like. The support circuits 320 comprise well known circuits that provide functionality to the CPU 315 such as clock circuits, cache, power supplies, I/O circuits, and the like.

The memory 310 may comprise random access memory, read-only memory, removable disk memory, flash memory, and various combinations thereof. The memory 310 is sometimes referred to a main memory and may in part, be used as cache memory or buffer memory. The memory 310 stores instructions comprising an operating system (if necessary), a text message payload generator 325, a network communications module 330, an IP call setup module 335, an optional administrative control unit 340, and a database 345. The operating system coordinates communication among the modules and the CPU 315 that executes the instructions stored in memory 310. The database 345 may store information about the user devices and the IP text message adapter 136 such as data for a connection to the cellular network 130 and user account data for connecting to the IP telephony network 125. The optional administrative control unit 340 includes instructions for an IP telephony provider to disconnect user devices (e.g., in an instance of a non-paying customer or a user in violation of terms of use policies).

The text message payload generator 325 comprises a set of instructions to retrieve data for establishing a call via the IP telephony network 125. The payload may include an SIP message requesting a connection (e.g., SIP INVITE) and proxy information (e.g., IP address and port number) to connect to the IP telephony network 125. The text message payload generator also encodes the SIP message as a text message. In alternative embodiments, the text message payload generator may generate the corresponding SIP message data and the payload is incorporated into a generated text message by the text message generator 220.

The network communications module 330 comprises a set of instructions to retrieve data from the database 345 identifying a recipient device 280 on a cellular network 130 such as subscriber identity module or an integrated circuit card identifier (ICCID). The identification information is used to package the text message payload and sending the text message via the gateway 122 to the cellular network 130. The network communications module 330 includes instructions to send the text message via the gateway 122.

The IP call setup module 335 comprises a set of instructions for establishing an IP communications session (e.g., VoIP, video conferencing, and the like). The IP call setup module 335 receives the response message from the IP text message adapter 136. Upon receiving the response message, the IP call setup module 335 coordinates the proxy server 215 and media relay 225 to establish a connection between the calling device 207 and recipient device 280.

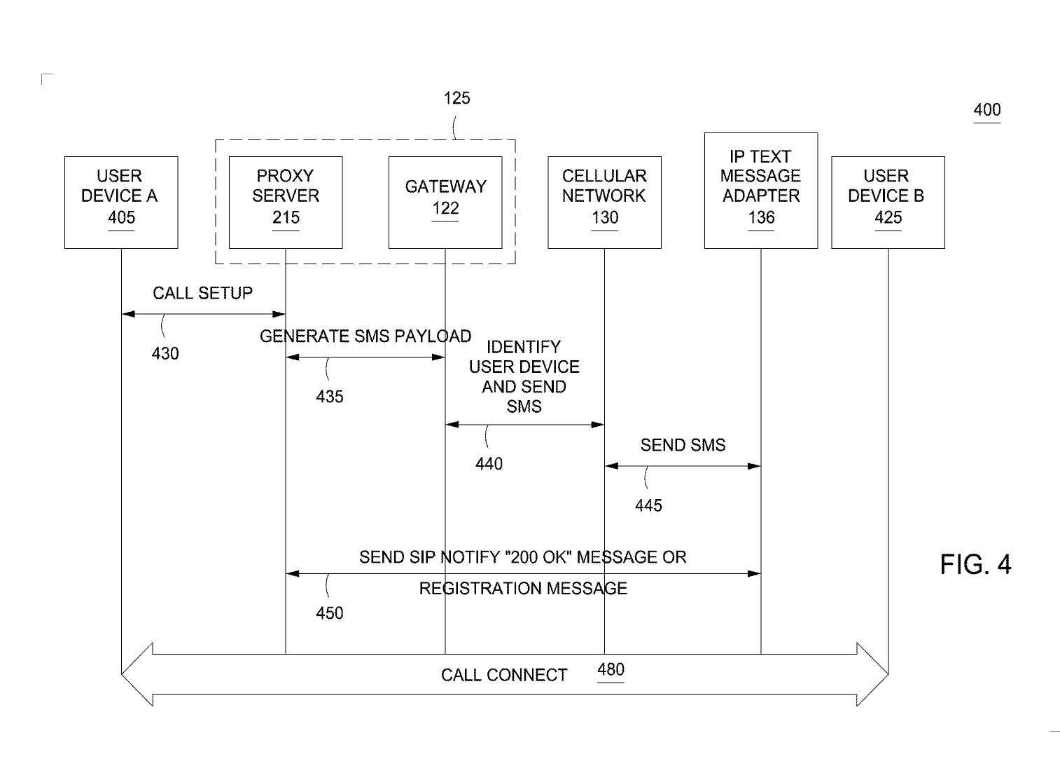

FIG. 4 is a call flow diagram of an exemplary method 400 for completing an IP call using a text message in accordance with one or more embodiments of the invention. The call flow diagram shows the various legs of establishing a communication session. Each leg of the call is identified via the network (or component thereof) that it passes through including the calling user device A 405, proxy server 215, gateway 122, cellular network 420, and recipient user device B 425. In some embodiments, the gateway 122 is integrated with the proxy server 215 as part of the IP telephony network 125.

As will be described further below, the method 400 is a combination of the steps from the methods 500 and 600. In the call request/setup period 430, the calling user device A 405 initiates a communication session request to the proxy server 215 for connecting to the recipient user device B 425.

In the period 435, a text message (e.g., SMS) is generated that contains data to connect to the proxy server 215. The text message payload may include a SIP request, IP address, ICCID, and the like. The text message is then sent from the gateway 122 to the cellular network 130 in the period 440. The cellular network 130 relays the text message in the period 445 to the IP text message adapter 136. The IP text message adapter 136 parses the message and in some embodiments, causes User Device B to ring.

The IP text message adapter 136 processes the text message and based on the payload sends a response message in the period 450 to the proxy server 215. The response message may be SIP notification information or data regarding registering the recipient user device B 425 with the proxy server 215. The proxy server 215 then coordinates establishing the communication session 480 with the media relay server (not shown) to connect the calling user device A 405 and recipient user device B 425. The proxy server 215 negotiates IP addresses and ports such that the media relay server may exchange audio and/or video data between the calling user device A 405 and recipient user device B 425.

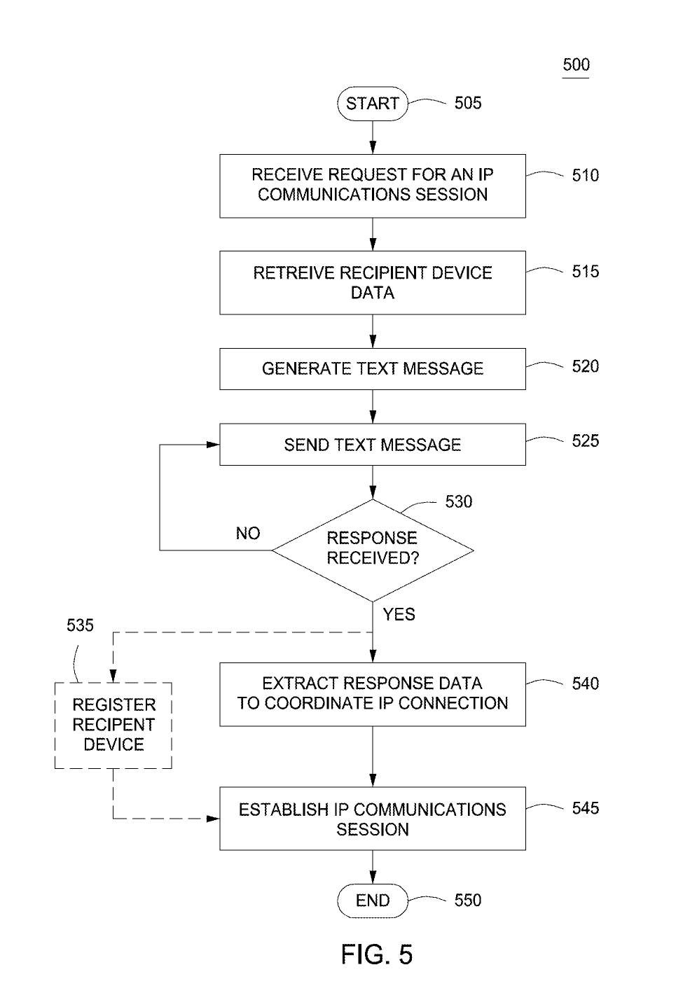

FIG. 5 is a flow diagram of an exemplary method for completing an IP call using a text message in accordance with one or more embodiments of the invention. The method 500 is implemented by the IP telephony network 125, IP text message adapter 136, and call establishment unit 295 described in the above figures above.

The method 500 begins at step 505 and continues to step 510. At step 510, a request from a calling device (e.g., calling device 207) for an IP communication session with a recipient device (e.g., recipient device 280) is received. The request is received by an IP network (e.g., IP telephony network 125). In some embodiments, the request from calling device 207 may be forwarded to IP telephony network 125 via one or more intermediary networks.

At step 515, recipient device data is retrieved. Recipient device data includes device identification information such as a ICCID or SIM serial number to locate the device on the cellular network. Recipient device data may also include data to complete the IP communications session with the calling device such as an SIP request, IP address, and the like to connect to a proxy server on the IP network. In some embodiments, recipient device data may also include user account information for an IP network or IP communications provider.

Next at step 520, a text message (e.g., SMS message) is generated based on the recipient device data retrieved at step 515. A payload data of the text message include information for the recipient device to connect to the proxy server and a media relay. In some embodiments, the payload data includes connectivity data such as IP addresses, port numbers, device identifiers, subscriber identifiers, authentication information, time to connect and the like.

At step 525, the text message is sent to the cellular network as negotiated by a wireless gateway in the IP network. The wireless gateway sends the text message based on the device identification information from step 515.

At step 530, the IP telephony network 125 and/or call establishment unit 295 determines whether a response message has been received by the IP network from the recipient device. The response message may be a SIP message such as an “SIP OK 200” message. In other embodiments, the response may be a text message routed from the cellular network to the wireless gateway. However, a SIP message is a preferred embodiment as the latency is lower than responding via other signaling methods such as a text message, email, and the like.

If no response message has been received within a specified time period, the method 500 reverts to step 525 where another text message may be sent. In some embodiments, the maximum number of text message retries can be set. For example, the maximum number of retries may be set to 3 text messages, after which, the call connection is no longer attempted. If however, a response is received, the method 500 proceeds to step 540. The response may include data/information to establish a communication session between the calling device and the recipient device. The response data may include IP addresses, port numbers, device identifiers, subscriber identifiers, authentication information, time to connect and the like. At step 540, the response data is decoded and extracted to coordinate an IP connection of the media relay and proxy server with the recipient device and calling device. At step 545, an IP communication session is completed by connecting the recipient device to the calling device across the IP network. The method 500 then ends at step 550.

In an optional embodiment, the method 500 may alternatively proceed from step 530 to step 535 where the recipient device is registered on the IP network. From step 535, the method 500 proceeds to step 545 to complete an IP communications session by connecting the calling device and recipient device across the IP network. The method 500 then ends at step 550.

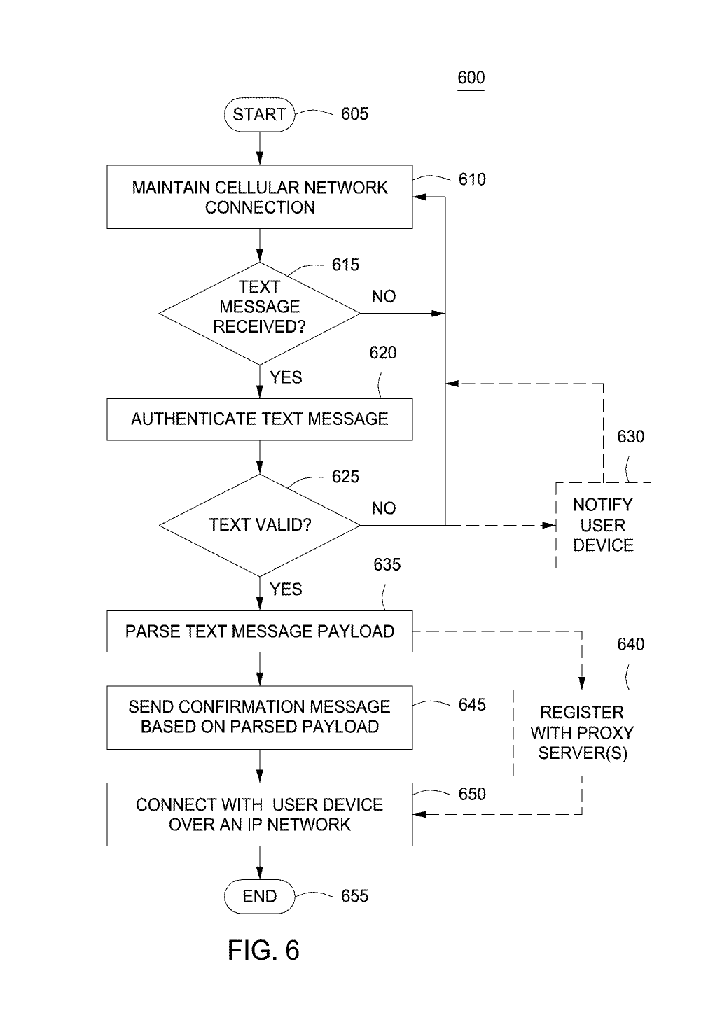

FIG. 6 is a flow diagram of an exemplary method 600 for completing an IP call by receiving a text message in accordance with one or more embodiments of the invention. The method 600 is implemented by the embodiments discussed above in FIGS. 1-5 and the IP text message adapter 136.

The method 600 begins at step 605 and continues to step 610. At step 610 the text message adapter (e.g., IP text message adapter 136) maintains an active connection to a cellular network such as the cellular network 130 (e.g., long term evolution (LTE), 3G, 4G, GSM, and the like). The cellular network is capable of sending text messages.

At step 615, a determination is made as to whether a text message is received from the cellular network. If no text message is received, the method 600 reverts back to step 610. If however, a text message is received, the method 600 continues to step 620.

At step 620, the text message is authenticated by the IP text message adapter 136. Specifically, the authentication may be performed by validation module 250. The text message may be decoded and evaluated against expected tokens or keys to verify the text message originates from an IP communication service.

Next at step 625, a determination is made as to whether the text message is valid and passed authentication. If the text message is invalid, the IP text message adapter 136 returns to a passive state by maintaining the cellular network connection at step 610. Optionally, a notification may be sent by the IP text message adapter 136 to a user device (e.g., recipient device 280) at step 630. If however, the text message is determined to be valid, the method 600 continues to step 635.

At step 635, the text message payload data is parsed. Using the parsed text message payload data, the recipient device 280 sends a confirmation message to the IP network (e.g., IP telephony network 125) at step 645.

Next at step 650, the IP text message adapter 136 connects to the recipient device 280 across the IP telephony network 125 in a communications session. The communications session is facilitated by connections to a proxy server 215 and media relay 225 through the Internet 110 and cellular network 130. The media relay 225 exchanging streaming audio and/or video between the recipient device 280 and calling device 270. The method 600 then ends at step 655.

Alternatively, from step 635, the parsed message payload data may be used to trigger a registration message to register the recipient device 280 with the IP network at step 640. The method 600 then proceeds to step 650. At step 650, a communications session is established between the recipient device 280 and a calling device 207 across the IP telephony network 125. The communications session is facilitated by connections to a proxy server 215 and media relay 225. The media relay 225 exchanging streaming audio and/or video between the recipient device 280 and calling device 270. The method 600 then ends at step 655.

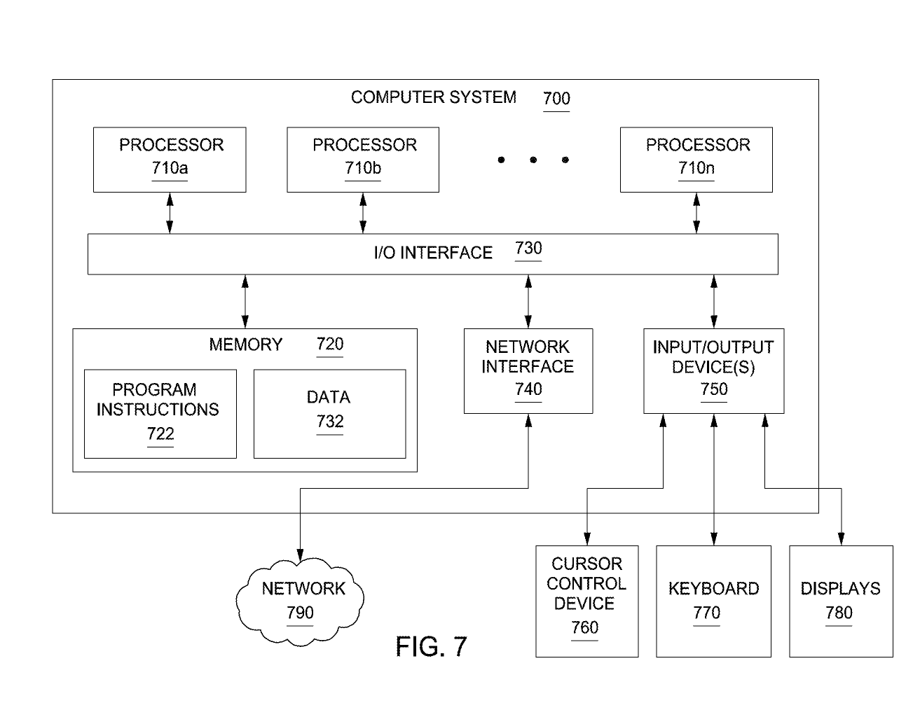

FIG. 7 is a depiction of a computer system 700 that can be utilized in various embodiments of the present invention. The computer system 700 includes substantially similar structure comprising servers or electronic devices in the aforementioned embodiments.

Various embodiments of methods and system authenticating users for completing communication sessions using text messages, as described herein, may be executed on one or more computer systems, which may interact with various other devices. One such computer system is computer system 700 illustrated by FIG. 7, which may in various embodiments implement any of the elements or functionality illustrated in FIGS. 1-6. In various embodiments, computer system 700 may be configured to implement methods described above. The computer system 700 may be used to implement any other system, device, element, functionality or method of the above-described embodiments. In the illustrated embodiments, computer system 700 may be configured to implement methods 500, and 600 as processor-executable executable program instructions 722 (e.g., program instructions executable by processor(s) 710) in various embodiments.

In the illustrated embodiment, computer system 700 includes one or more processors 710a-710n coupled to a system memory 720 via an input/output (I/O) interface 730. Computer system 700 further includes a network interface 740 coupled to I/O interface 730, and one or more input/output devices 760, such as cursor control device 670, keyboard 770, and display(s) 780. In some embodiments, the keyboard 770 may be a touchscreen input device.

In various embodiments, any of the components may be utilized by the system to authenticate a text message to establish an IP communications session as described above. In various embodiments, a user interface may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, computer system 700 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments, the processors 710 may be general-purpose or embedded processors implementing any of a variety of instruction set architectures (ISAs). In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, cellular networks, 802.11x networks, WLANs, some other electronic data network, or some combination thereof. In various embodiments, network interface 740 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 750 may, in some embodiments, include one or more display devices, keyboards, keypads, cameras, touchpads, touchscreens, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the methods described above, such as the methods illustrated by the flowchart of FIGS. 5, and 6. In other embodiments, different elements and data may be included.

Those skilled in the art will appreciate that computer system 700 is merely illustrative and is not intended to limit the scope of embodiments. In particular, the computer system and devices may include any combination of hardware or software that can perform the indicated functions of various embodiments, including computers, network devices, Internet appliances, smartphones, tablets, PDAs, wireless phones, pagers, and the like. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A method for Internet Protocol (IP) communication completion via a wireless network, comprising:
receiving a request from a first device to setup an IP telephony communications session with a second device;
generating, based on user device data retrieved for the second device, a first message based on a first communication protocol including telecommunication invitation data to complete the IP telephony communications session;
sending the first message to the second device;
receiving a response message based on a second communication protocol from the second device; and
connecting the second device with the first device to establish the IP telephony communications session.

2. The method of claim 1, wherein the first message is a Short Message Service (SMS) message and wherein the first communication protocol is SMS.

3. The method of claim 2, wherein the SMS message is sent to the second device via a wireless gateway coupled to a wireless network.

4. The method of claim 1, wherein the telecommunication invitation data includes information included in an Session Initiation Protocol (SIP) INVITE message.

5. The method of claim 1, wherein the user device data includes at least one of a subscriber identity or an integrated circuit card identifier (ICCID) associated with the second device.

6. The method of claim 1, wherein the response message is a Session Initiation Protocol (SIP) notification message and wherein the second protocol is SIP.

7. The method of claim 6, wherein the SIP notification message is received by a proxy server to coordinate connection with a media relay for the IP telephony communications session.

8. The method of claim 1, further comprising registering the second device with a registration server upon receiving the response message from the second device.

9. The method of claim 1, wherein the established IP telephony communications session is completed using Voice over Internet Protocol (VolP).

10. A method for completion of an Internet Protocol (IP) communications session in an IP telephony communications system, comprising:
receiving a first message based on a first communication protocol from a wireless network containing telecommunication invitation data to establish the IP communications session with a first device;
generating a response message in a second communication protocol based on the telecommunication invitation data from the first message;
sending the response message to the IP telephony communications system to establish the IP communications session with the first device; and
communicating with the first device via the IP communications session.

11. The method of claim 10, wherein the first message is a Short Message Service (SMS) message and wherein the first communication protocol is SMS.

12. The method of claim 10, wherein the telecommunication invitation data includes information included in an Session Initiation Protocol (SIP) INVITE message.

13. The method of claim 10, wherein the telecommunication invitation data includes at least one of a subscriber identity or an integrated circuit card identifier (ICCID) associated with at least one of the first device or a recipient device.

14. The method of claim 10, wherein the response message is a Session Initiation Protocol (SIP) notification message and wherein the second communication protocol is SIP.

15. The method of claim 14, wherein the SIP notification message is received by a proxy server to coordinate connection with a media relay for the IP telephony communications session.

16. The method of claim 10, wherein the response message further comprises sending registration data to register a recipient device with a registration server.

17. A system for Internet Protocol (IP) communication completion via a wireless network comprising:
a text message generation interface;
a wireless gateway coupled to a wireless network; and
at least one proxy server, the system configured to:
receive a request from a first device to setup an IP telephony communications session with a second device;
generate based on user device data retrieved for the second device, a first message based on a first communication protocol including telecommunication invitation data to complete the IP telephony communications session;
send the first message to the second device;
receive a response message based on a second communication protocol from the second device; and
connect the second device with the first device to establish the IP telephony communications session.

18. The system of claim 17, wherein the first message is a Short Message Service (SMS) message and wherein the first communication protocol is SMS.

19. The system of claim 18, wherein the SMS message is sent to the second device via a wireless gateway coupled to a wireless network.

20. The system of claim 17, wherein the telecommunication invitation data includes information included in an Session Initiation Protocol (SIP) INVITE message.

21. The system of claim 17, wherein the user device data stored in a database includes at least one of a subscriber identity or an integrated circuit card identifier (ICCID) associated with the second device.

22. The system of claim 17, wherein the response message is a SIP notification message is received by the at least one proxy server.

23. The system of claim 22, wherein the SIP notification message is received by the at least one proxy server to coordinate connection with a media relay server for the IP telephony communications session.

24. The system of claim 23, further comprising registering the second device with the at least one registration server upon receiving the response message from the second device.

25. An apparatus for completion of an Internet Protocol (IP) communications session in an IP telephony communications system with a recipient device comprising:
a call setup module configured to:
receive a first message based on a first communication protocol from a wireless network containing telecommunication invitation data to establish the IP communications session with a first device;
generate a response message in a second communication protocol based on the telecommunication invitation data from the first message;
send the response message to the IP telephony communications system to establish the IP communications session with the first device; and
communicate with the first device via the IP communications session.
